(19) United States
(12) Patent Application Publication
(10) Pub. No.: US 2013/0236875 A1
(43) Pub. Date: Sep. 12, 2013

(54) CHOICE GENERATION METHOD FOR NUMERICAL MULTIPLE CHOICE QUESTION

(71) Applicants: TING-CHAO HOU, CHIAYI (TW); MENG-HSI CHIU, TAICHUNG CITY (TW)

(72) Inventors: TING-CHAO HOU, CHIAYI (TW); MENG-HSI CHIU, TAICHUNG CITY (TW)

(73) Assignee: NATIONAL CHUNG CHENG UNIVERSITY, CHIA-YI (TW)

(21) Appl. No.: 13/589,381

(22) Filed: Aug. 20, 2012

(30) Foreign Application Priority Data
Mar. 9, 2012 (TW) 101108192

(51) Int. Cl. G09B 7/00

(52) U.S. Cl. 434/322

(57) ABSTRACT

A choice generation method for a numerical multiple choice question comprises steps: establishing a numerical multiple choice question, and obtaining a correct numerical answer of the numerical multiple choice question; determining the number of numerical choices for the numerical multiple choice question; and generating a plurality of the numerical choices either greater or smaller than the correct numerical answer according to a choice-answer relationship. The present invention applies to generate numerical choices for a numerical multiple choice question, and the generated numerical choices are different from the numerical correct answer.

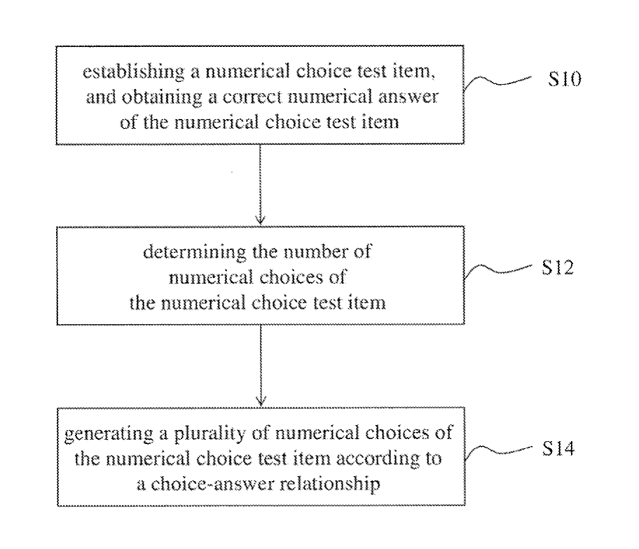

### BACKGROUND OF THE INVENTION

1. Field of the Invention

The present invention relates to a choice generation method for a multiple choice question, particularly to a choice generation method for a numerical multiple choice question,

2. Description of the Related Art

In an examination, multiple choice questions are more convenient for test scorers. However, the conventional numerical choices of a multiple choice question are usually of fixed values or order. Even though the numerical choices are arranged randomly, the order of the numerical choices is still the same after the numerical choices are rearranged according to their values. Thus, the respondents may select the answers not via solving the questions hut via memorizing the answers. An approach to solve the problem is to reform the questions and choices and add them to the test item database. However, such an approach will make the test item database bulky and hard to administrate.

In order to solve the abovementioned problems, some test item databases provide fill-in-the-blank questions containing some dependent variables, such as n1to10 for example, a test question is “the length of a park trail is 40 m, and the jogging speed of a person is n1to10 m/sec; how much time will the person take to walk through the park trail?” The equation to solve the question is “time=length÷speed=40 /n1to10”. Suppose that n1to10=7. Thus is obtained the answer 40/7=5.7142 . . . by substituting 7 for n1to10 the equation. Therefore, the respondent should fill [0/7=5.7142 . . . ] the blank.

However, how many digits behind the decimal point should be used is likely to be a controversial issue in the abovementioned fill-in-the blank questions. Therefore, some test item databases provide choice-type calculation questions to solve the abovementioned problem, wherein each test question has some dependent variables (such as n1 to 10). Further, the correct answer of a choice-type calculation question may be substituted into various equations to generate choices of the choice-type calculation question, and the choices are varied with the value of the dependent variable in the choice-type calculation question. For example, the choices of a choice-type calculation question may be stated as follows: a: (40/n1 to 10) seconds; b: (40/n1 to 10)*2 seconds; c: (40/n1 to 10)/2 seconds; d; (40/n1 to 10)/3 seconds, wherein a is a correct answer and b, c, d are incorrect answers. Suppose that n1 to 10=5. Thus, the choice-type calculation question is stated as follows: the length of a park trail is 40 m, and the jogging speed of a person is 5 m/see; how much time will the person take to walk through the park trail a, 8.00 seconds; b. 2.67 seconds; c, 16.0 seconds; d. 4.00 seconds. The choices arranged from large to small are 16, 8, 4, 2.67. and the correct answer is 8. Suppose that n1 to 10=7. The choices are a. 5.71 seconds; b. 11.4 seconds; c. 2.86 seconds; d. 1.9 seconds. The choices arranged from large to small are 11.4, 5.71, 2,86, 1.9, and the correct answer is 5.71. Consequently, no matter whether n1 to 10=5 or 7, the correct answer is always the second largest choice. Thus, the respondents are easy to see through the rule and able to guess the correct answers. Then, the calculation questions become memorization tests.

Accordingly, the present invention proposes a choice generation method for a multiple choice question to solve the abovementioned problems.

### SUMMARY OF THE INVENTION

The primary objective of the present invention is to provide a choice generation method for a numerical multiple choice question, which applies to an item database to generate choices of a numerical multiple choice question, and which uses a random integer variable to vary the order of the correct answer appearing in the sequence of the numerical choices

Another objective of the present invention is to provide a choice generation method for a numerical multiple choice question, which generates numerical choices in form of an arithmetic or geometric sequence including the correct answer.

To achieve the abovementioned objectives, the present invention proposes a choice generation method for a numerical multiple choice question, which comprises steps: establishing a numerical multiple choice question; obtaining a correct numerical answer of the numerical multiple choice question; determining the number of the numerical choices of the numerical multiple choice question; and generating a plurality of numerical choices either greater or smaller than the correct numerical answer according to a choice-answer relationship.

Below, embodiments are described in detail to make easily understood the objectives, technical contents, characteristic and accomplishments of the present invention.

### BRIEF DESCRIPTION OF THE DRAWINGS

The FIG. shows a flowchart of a choice generation method for a numerical multiple choice question according to one embodiment of the present invention.

### DETAILED DESCRIPTION OF THE INVENTION

Refer to the FIG. showing a flowchart of a choice generation method for a numerical multiple choice question according to one embodiment of the present invention. In Step S10, establish a numerical multiple choice question. For example, the length of a park trail is 40 m, and the jogging speed of a person is 5 m/sec; how much time will the person take to walk through the park trail After calculation, the correct answer of the question is 8 seconds. Next, in Step S12, determine the number of the numerical choices of the numerical multiple choice question. Next, in Step S14, generate a plurality of numerical choices either greater or smaller than the correct answer according to a choice-answer relationship, if the user intends to present the numerical choices in form of an arithmetic sequence including the correct answer, he may adopt a choice-answer relationship expressed by Equation (1):

$$choice ( c ) = a + {\sum }_{b = 0}^{[ {log}_{2} ( c + 1 ) ] - 1} pm ( d \cdot {2}^{b} ) \cdot {c}_{b} \qquad ( 1 )$$

wherein choice(e) is the value of the cth numerical choice, α the correct answer, and c_{b} the bth bit of c in the binary form (it is either 1 or 0), and wherein pm(d) may be expressed by Equation (2):

pm(d)=−d+X*d*2 (2)

wherein d is a common difference, and X an integer variable of 0 or 1. The auxiliary random integer variable X is used to vary the order of the correct answer appearing in the sequence of the numerical choices.

The process of the method of the present invention has been described above. The deduction of the equations and the exemplifications will be stated below. Equations (1) and (2) are mathematically deduced as follows:

$$chioce ( c ) = a + pm ( d \cdot {2}^{0} ) \cdot {c}_{0} + pm ( d \cdot {2}^{1} ) \cdot {c}_{1} + pm ( d \cdot {2}^{2} ) \cdot {c}_{2} + … + pm ( d \cdot {2}^{⌈ {log}_{2} ( c + 1 ) ⌉ - 1} ) \cdot {c}_{[ {log}_{2} ( c + 1 ) ] - 1} = a + {\sum }_{b = 0}^{⌈ {log}_{2} ( c + 1 ) ⌉ - 1} pm ( d \cdot {2}^{b} ) \cdot {c}_{b}$$

The numerical choices generated by the present invention features irregularity and unpredictability, which will be demonstrated in Theorem 1 and Theorem 2. Before proving the two theorems, we have to propose and prove three lemmas.

$$Lemma I \text{:} {c}_{b} = 0 , ∀ b > ⌈ {log}_{2} ( c + 1 ) ⌉ - 1$$

$$Proof \text{:} A proof by contradiction is used herein . \\ Suppose$$

$$∃ b > ⌈ log ( c + 1 ) - 11 ⌉ - 1 , {c}_{b} = 1$$

$${c}_{b} = 1 ⇒ c \geq {2}^{b} , \\ c + 1 \geq {2}^{b} + 1 , \\ {log}_{2} ( c + 1 ) \geq {log}_{2} ( {2}^{b} + 1 ) \cdot ⌈ {log}_{2} ( c + 1 ) ⌉ \geq ⌈ {log}_{2} ( {2}^{b} + 1 ) ⌉ = b + 1$$

$$b + 1 \leq ⌈ {log}_{2} ( c + 1 ) ⌉ , \\ b \leq ⌈ {log}_{2} ( c + 1 ) ⌉ - 1 , b \leq ⌈ {log}_{2} ( c + 1 ) - 1 ⌉ contradict the premise$$

$$b > ⌈ {log}_{2} ( c + 1 ) - 1 ⌉ - 1.$$

$$Therefore is proved Lemma I . \\ Lemma II \text{:} If choice ( c ) = a + {\sum }_{b = 0}^{⌈ {log}_{2} ( c + 1 ) ⌉ - 1} pm ( d \cdot {2}^{b} ) \cdot {c}_{b} , \\ choice ( c + {2}^{n} ) = choice ( c ) + pm ( d \cdot {2}^{n} ) , \\ ∀ c = 0 , 1 , 2 , … , {2}^{n} - 1.$$

$$Proof \text{:}$$

$$choice ( c + {2}^{n} ) = a + {\sum }_{b = 0}^{⌈ {log}_{2} ( c + {2}^{n} + 1 ) ⌉ - 1} pm ( d \cdot {2}^{b} ) \cdot {( c + {2}^{n} )}_{b} ( 1 ) \\ ∵ ⌈ {log}_{2} ( c + {2}^{n} + 1 ) ⌉ = n + 1 , ∀ c = 0 , 1 , 2 , … , {2}^{n} - 1 \\ ∴ ( 1 ) = a + {\sum }_{b = 0}^{n + 1 - 1 = n} pm ( d \cdot {2}^{b} ) \cdot {( c + {2}^{n} )}_{b} = a + {\sum }_{b = 0}^{n - 1} pm ( d \cdot {2}^{b} ) \cdot {( c + {2}^{n} )}_{b} + {\sum }_{b = n}^{n} pm ( d \cdot {2}^{b} ) \cdot {( c + {2}^{n} )}_{b} ( 2 ) \\ ∵ {( c + {2}^{n} )}_{b} = {c}_{b} , ∀ b = 0 , 1 , 2 , … , n - 1 {and ( c + {2}^{n} )}_{n} = 1 , ∀ c = 0 , 1 , 2 , … , {2}^{n} - 1 \\ ∴ ( 2 ) = a + {\sum }_{b = 0}^{n - 1} pm ( d \cdot {2}^{b} ) \cdot {c}_{b} + {\sum }_{b = n}^{n} pm ( d \cdot {2}^{b} ) \cdot 1 = a + {\sum }_{b = 0}^{n - 1} pm ( d \cdot {2}^{b} ) \cdot {c}_{b} + pm ( d \cdot {2}^{n} ) ( 3 )$$

$$( a ) When c = {2}^{n - 1} , {2}^{n - 1} + 1 , {2}^{n - 1} + 2 , … , {2}^{n} - 1 , \\ ∵ ⌈ {log}_{2} ( c + 1 ) ⌉ - 1 = n - 1 , \\ ∴ {\sum }_{b = 0}^{n - 1} pm ( d \cdot {2}^{b} ) \cdot {c}_{b} = {\sum }_{b = 0}^{⌈ {log}_{2} ( c + 1 ) ⌉ - 1} pm ( d \cdot {2}^{b} ) \cdot {c}_{b} \\ ( b ) When c = 0 , 1 , 2 , … , {2}^{n - 1} - 1 , \\ ∵ ⌈ {log}_{2} ( c + 1 ) ⌉ - 1 < n - 1 and$$

$$Lemma 1 \text{:} {c}_{b} = 0 , ∀ b > ⌈ {log}_{2} ( c + 1 ) ⌉ - 1 \\ ∴ {\sum }_{b = 0}^{n - 1} pm ( d \cdot {2}^{b} ) \cdot {c}_{b} = {\sum }_{b = 0}^{⌈ {log}_{2} ( c + 1 ) ⌉ - 1} pm ( d \cdot {2}^{b} ) \cdot {c}_{b} + {\sum }_{b = ⌈ {log}_{2} ( c + 1 ) ⌉}^{n - 1} pm ( d \cdot {2}^{b} ) \cdot 0 = {\sum }_{b = 0}^{⌈ {log}_{2} ( c + 1 ) ⌉ - 1} pm ( d \cdot {2}^{b} ) \cdot {c}_{b} \\ ( a ) , ( b ) ⇒ ( 3 ) = a + {\sum }_{b = 0}^{⌈ {log}_{2} ( c + 1 ) ⌉ - 1} pm ( d \cdot {2}^{b} ) \cdot {c}_{b} + pm ( d \cdot {2}^{n} ) = choice ( c ) + pm ( d \cdot {2}^{n} ) ,$$

Therefore is proved Theorem II.

### Theorem I:

If

$$choice ( c ) = a + {\sum }_{b = 0}^{⌈ {log}_{2} ( c + 1 ) ⌉ - 1} pm ( d \cdot {2}^{b} ) \cdot {c}_{b} ,$$

choice(0)˜choice(2ⁿ−1), ∀nεN the feature that they can generate 2ⁿ sets of arithmetic sequences each having α, an identical common difference d, and a total number of terms 2ⁿ.

### Proof:

When n = 1,
choice(0) = a, choice(1) = a + pm(d · 2⁰) = a + pm(d · 1) = a + pm(d)
When pm(d) = −d,

| | |
|---|---|
| choice(1) = | choice(0) = a |
| a + pm(d) = a − d | |

When pm(d) = +d,

| | |
|---|---|
| choice(0) = a | choice(1) = |
| | a + pm(d) = a + d |

Therefore, there are 2ⁿ2¹=2 sets of arithmetic sequences each having α, an

identical common difference d, and a total number of terms 2ⁿ=2¹=2.

When n=2,

It is learned from Lemma II that choice(c+2¹)=choice(c)+pm(d·2^{1l}).

When c=2, express 2 of choice(2) by the binary system.

Thus, choice(2)=choice(0+2¹)=choice(0)+pm(d·2¹)=choice(0)÷pm(d·2).

When c=3, express 3 of choice(3) by the binary system.

Thus, choice(3)=choice(1+2¹)=choice(1)÷pm(d·2¹)=choice(1)÷pm(d·2).

When pm(d · 2) = −d · 2,

| | | | | |
|---|---|---|---|---|
| choice(3) = | choice(2) = | choice(1) = | choice(0) = a | |
| choice(1) − | choice(0) − | a − d · 1 | | |
| d · 2 = | d · 2 = | | | |
| a − d − d · 2 = | a − d · 2 | | | |
| a − d · 3 | | | | |
| | choice(2) = | choice(3) = | choice(0) = a | choice(1) = |
| | choice(0) − | choice(1) − | | a + d · 1 |
| | d · 2 = | d · 2 = | | |
| | a − d · 2 | a + d − d = | | |
| | | a − d · 1 | | |

When pm(d · 2) = +d · 2,

| | | | | |
|---|---|---|---|---|
| choice(1) = | choice(0) = a | choice(3) = | choice(2) = | |
| a − d · 1 | | choice(1) + | choice(0) + | |
| | | d · 2 = | d · 2 = | |
| | | a − d + d · 2 = | a + d · 2 | |
| | | a + d · 1 | | |
| | choice(0) = a | choice(1) = | choice(2) = | choice(3) = |
| | | a + d · 1 | choice(0) + | choice(1) + |
| | | | d · 2 = | d · 2 = |
| | | | a + d · 2 | a + d + d · 2 = |
| | | | | a + d · 3 |

As shown in abovementioned cases of pm(d·2)=−d·2 and pm(d·2)=+d·2, when n=2, there are totally 2ⁿ=2²=4 sets of arithmetic sequences each having α, an identical common difference d, and a total number of terms 2ⁿ=2²=4.

Suppose that when n=k, Theorem I is true. In other words, when n=k, there are 2^{k} sets of arithmetic, sequences each having α, an identical, common difference d, and a total number of terms 2^{k}:

| | | | | | | | | |
|---|---|---|---|---|---|---|---|---|
| a − d · | a − d · | a − d · | . . . | a | | | | |
| (2^{k} − 1) | (2^{k} − 2) | (2^{k} − 3) | | | | | | |
| | a − d · | a − d · | . . . | a | a + d · 1 | | | |
| | (2^{k} − 2) | (2^{k} − 3) | | | | | | |
| | | a − d · | . . . | a | a + d · 1 | a + | | |
| | | (2^{k} − 3) | | | | d · 2 | | |
| | | | . . . | . . . | . . . | . . . | . . . | |
| | | | | a | a + d · 1 | a + | . . . | a + d · |
| | | | | | | d · 2 | | (2^{k} − 1) |

When n=k+1, it is learned from Lemma II that choice(c+2^{k})=choice(c)+pm(d·2^{k}), ∀c=0,1,2, . . . , 2−1.

When pm(d·2^{k})=−d·2^{k}, 2^{k} rows are generated in the table. As the next term is formed via adding −d·2^{k} to the current term, the next term is arranged at the left of the current term in the table. When pm(d·2^{k})=+d·2^{k}, there are also 2^{k} rows generated in the table. As the next term is formed via adding +d·2^{k} to the current term, the next term is arranged at the right of the current term in the table. As shown in abovementioned cases of pm(d·2^{k})=−d·2^{k} and pm(d·2^{k})=+d·2^{k}, when n=k+1, there are totally 2^{k}+2^{k}=2^{k+1} sets of arithmetic sequences each having α, an identical common difference d, and a total number of terms 2^{k+1}. Thus is proved Theorem I.

Below, a two-choice multiple choice question and a four-choice multiple choice question are used as the embodiments to demonstrate how the present invention generates numerical choices in form of an arithmetic sequence for a numerical multiple choice question. Firstly, define a two-choice numerical multiple choice question. The test question is “the length of a park trail is 40 m, and the jogging speed of a person is n1 to 10 m/sec; how much time will the person take to walk through the park trail?” The equation for solving the question is time=length÷speed=40/n1 to 10. The correct, answer is (40/n1 to 10) seconds. Thus, Choice 1 is (40/n1 to 10)+pm(d·2⁰) wherein n1 to 10 is a random integer number of from 1 to 10. In this embodiment, n1 to 10 is assigned to be 5, and the correct answer is 8seconds. In this embodiment, d of pm(d·2⁰) is assigned to be 1. However, d may be a random positive or negative integer in the present invention. Further, X is assigned to be 0 or 1 so as to vary the order of the correct answer appearing in the sequence of the numerical choices.

When X=0, the numerical choices are calculated as follows:

$$Choice 0 ( the correct answer ) = choice ( 0 ) = a = ( 40 / n 1 to 10 ) = ( 40 / 5 ) = 8 ;$$

$$Choice 1 = choice ( 1 ) = a + pm ( d \cdot {2}^{0} ) = 1 + pm ( d \cdot 1 ) = a + pm ( d ) = ( 40 / n 1 to 10 ) + ( - 1 + X * 2 ) = ( 40 / 5 ) + ( - 1 + 0 * 2 ) = 8 - 1 = 7.$$

The choices arranged from large to small are 8, 7. The correct answer is the largest one among the choices.

When X=1, the numerical choices arc calculated as follows:

Choke 0 (the correct answer)=choice(0)=a=(40/n1 to 10)=(40/5)=8;

Choice 1=(40/n1 to 10)+(−1+X*2)=(40/5)+(−1+1*2)=8+1=9.

The choices arranged from large to small are 9, 8. The correct answer is the second largest one among the choices.

Next, a four-choice multiple choice question is used as the embodiment to demonstrate the present invention. Similarly, X is 0 or 1 in the embodiment. From Lemma II, it is learned that choice(c+2¹)=choice(c)+pm(d·2¹), ∀c=0,2¹−1=0,1. Four

numerical choices of the multiple choice question are calculated as follows.

$$Choice 0 ( the correct answer ) = choice ( 0 ) = a = ( 40 / n 1 to 10 ) = ( 40 / 5 ) = 8 ;$$

$$Choice 1 = choice ( 1 ) = a + pm ( d \cdot {2}^{0} ) = a + pm ( d \cdot 1 ) = a + pm ( d ) = ( 40 / n 1 to 10 ) + ( - 1 + X * 2 ) ;$$

$$Choice 2 = choice ( 2 ) = choice ( 0 + {2}^{1} ) = choice ( 0 ) + pm ( d \cdot {2}^{1} ) = choice ( 0 ) + pm ( d \cdot 2 ) = ( 40 / n 1 to 10 ) + ( - 2 + {X}_{2} * 4 ) ; and$$

$$Choice 3 = choice ( 3 ) = choice ( 1 + {2}^{1} ) = choice ( 1 ) + pm ( d \cdot {2}^{1} ) = choice ( 1 ) + pm ( d \cdot 2 ) = ( 40 / n 1 to 10 ) + ( - 1 + X * 2 ) + ( - 2 + {X}_{2} * 4 ) ,$$

wherein n1 to 10 is a random integer number of from 1 to 10 and X is either 0 or 1. In this embodiment, n1 to 10 is assigned to be 5, and (X, X₂) have four combinations; (0, 0), (1, 0), (0, 1)and (1, 1).

$$When ( X , {X}_{2} ) is ( 0 , 0 ) , \\ Choice 0 ( the correct answer ) = choice ( 0 ) = a = ( 40 / n 1 to 10 ) = ( 40 / 5 ) = 8 ;$$

$$Choice 1 = ( 40 / n 1 to 10 ) + ( - 1 + X * 2 ) = ( 40 / 5 ) + ( - 1 + 0 * 2 ) = 8 + ( - 1 ) = 7 ;$$

$$Choice 2 = ( 40 / n 1 to 10 ) + ( - 2 + {X}_{2} * 2 ) = ( 40 / 5 ) + ( - 2 + 0 * 4 ) = 8 + ( - 2 ) = 6 ; and$$

$$Choice 3 = ( 40 / n 1 to 10 ) + ( - 1 + X * 2 ) + ( - 2 + {X}_{2} * 4 ) = ( 40 / 5 ) + ( - 1 + 0 * 2 ) + ( - 2 + 0 * 4 ) = 8 + ( - 1 ) + ( - 2 ) = 5.$$

The choices arranged from large to small are 8, 7, 6, 5. The correct answer is the largest one among the choices.

$$When ( X , {X}_{2} ) is ( 1 , 0 ) , \\ Choice 0 ( the correct answer ) = choice ( 0 ) = a = ( 40 / n 1 to 10 ) = ( 40 / 5 ) = 8 ;$$

$$Choice 1 = ( 40 / n 1 to 10 ) + ( - 1 + X * 2 ) = ( 40 / 5 ) + ( - 1 + 1 * 2 ) = 8 + 1 = 9 ;$$

$$Choice 2 = ( 40 / n 1 to 10 ) + ( - 2 + {X}_{2} * 2 ) = ( 40 / 5 ) + ( - 2 + 0 * 4 ) = 8 + ( - 2 ) = 6 ; and$$

$$Choice 3 = ( 40 / n 1 to 10 ) + ( - 1 + X * 2 ) + ( - 2 + {X}_{2} * 4 ) = ( 40 / 5 ) + ( - 1 + 1 * 2 ) + ( - 2 + 0 * 4 ) = 8 + 1 + ( - 2 ) = 7.$$

The choices arranged from large to small are 9, 8, 7, 6. The correct answer is the second largest one among the choices.

$$When ( X , {X}_{2} ) is ( 0 , 1 ) , \\ Choice 0 ( the correct answer ) = choice ( 0 ) = a = ( 40 / n 1 to 10 ) = ( 40 / 5 ) = 8 ;$$

$$Choice 1 = ( 40 / n 1 to 10 ) + ( - 1 + X * 2 ) = ( 40 / 5 ) + ( - 1 + 0 * 2 ) = 8 + ( - 1 ) = 7 ;$$

$$Choice 2 = ( 40 / n 1 to 10 ) + ( - 2 + {X}_{2} * 2 ) = ( 40 / 5 ) + ( - 2 + 1 * 4 ) = 8 + 2 = 10 ; and$$

$$Choice 3 = ( 40 / n 1 to 10 ) + ( - 1 + X * 2 ) + ( - 2 + {X}_{2} * 4 ) = ( 40 / 5 ) + ( - 1 + 0 * 2 ) + ( - 2 + 1 * 4 ) = 8 + ( - 1 ) + ( - 2 ) = 9.$$

The choices arranged from large to small are 10, 9, 8, 7. The correct answer is the third largest one among the choices.

$$When ( X , {X}_{2} ) is ( 1 , 1 ) , \\ Choice 0 ( the correct answer ) = choice ( 0 ) = a = ( 40 / n 1 to 10 ) = ( 40 / 5 ) = 8 ;$$

$$Choice 1 = ( 40 / n 1 to 10 ) + ( - 1 + X * 2 ) = ( 40 / 5 ) + ( - 1 + 1 * 2 ) = 8 + 1 = 9 ;$$

$$Choice 2 = ( 40 / n 1 to 10 ) + ( - 2 + {X}_{2} * 2 ) = ( 40 / 5 ) + ( - 2 + 1 * 4 ) = 8 + 2 = 10 ; and$$

$$Choice 3 = ( 40 / n 1 to 10 ) + ( - 1 + X * 2 ) + ( - 2 + {X}_{2} * 4 ) = ( 40 / 5 ) + ( - 1 + 1 * 2 ) + ( - 2 + 1 * 4 ) = 8 + 1 + 2 = 11.$$

The choices arranged from large to small are 11, 10, 9, 8. The correct answer is the fourth largest one among the choices. From the abovementioned examples, it is known that the variable X can be used to vary the order of the correct answer in the numerical choices.

When the numerical choices are intended to be in form of a geometric sequence, they can be expressed by Equation (3):

$$choice ( c ) = a \cdot {\prod }_{b = 0}^{⌈ {log}_{2} ( c + 1 ) ⌉ - 1} {[ md ( {r}^{{2}^{b}} ) ]}^{{c}_{b}} \qquad ( 3 )$$

wherein choice(c) is the value of the cth choice, α the correct answer, and c_{b} the bth bit of c expressed in the binary system (0 or 1), and wherein md(r) is expressed by

$$md ( r ) = \frac{1}{r} + X * ( r - \frac{1}{r} ) \qquad ( 4 )$$

wherein r is the common ratio, and wherein X is a random integer variable (0 or 1) used to vary the order of the correct answer among the numerical choices.

The deduction of Equations (3) and (4) is mathematically deduced as follows:

$$choice ( c ) = a \cdot {[ md ( {r}^{{2}^{0}} ) ]}^{{c}_{0}} \cdot {[ md ( {r}^{{2}^{1}} ) ]}^{{c}_{1}} \cdot {[ md ( {r}^{{2}^{2}} ) ]}^{{c}_{2}} \cdot … \cdot {[ md ( {r}^{{2}^{⌈ {log}_{2} ( c + 1 ) ⌉ - 1}} ) ]}^{{c}_{⌈ {log}_{2} ( c + 1 ) ⌉ - 1}} = a \cdot {\prod }_{b = 0}^{⌈ {log}_{2} ( c + 1 ) ⌉ - 1} {[ md ( {r}^{{2}^{b}} ) ]}^{{c}_{b}}$$

$$Lemma III \text{:} If choice ( c ) = a \cdot {\prod }_{b = 0}^{⌈ {log}_{2} ( c + 1 ) ⌉ - 1} {[ md ( {r}^{{2}^{b}} ) ]}^{{c}_{b}} , \\ choice ( c + {2}^{n} ) = choice ( c ) \cdot md ( {r}^{{2}^{0}} ) , ∀ c = 0 , 1 , 2 , … , {2}^{n} - 1$$

$$Proof \text{:}$$

$$choice ( c + {2}^{n} ) = a \cdot {\prod }_{b = 0}^{⌈ {log}_{2} ( c + 1 ) ⌉ - 1} {[ md ( {r}^{{2}^{b}} ) ]}^{{( c + {2}^{b} )}_{b}} ( 4 ) \\ ∵ ⌈ {log}_{2} ( c + {2}^{n} + 1 ) ⌉ = n + 1 , ∀ c = 0 , 1 , 2 , … , {2}^{n} - 1 \\ ∴ ( 4 ) = a \cdot {\prod }_{b = 0}^{⌈ {log}_{2} ( c + {2}^{b} + 1 ) ⌉ - 1} {[ md ( {r}^{{2}^{b}} ) ]}^{{( c + {2}^{n} )}_{b}} = a \cdot {\prod }_{b = 0}^{n - 1} {[ md ( {r}^{{2}^{b}} ) ]}^{{( c + {2}^{n} )}_{b}} \cdot {\prod }_{b = n}^{n} {[ md ( {r}^{{2}^{b}} ) ]}^{( c + {2}^{n} ) b} ( 5 ) \\ ∵ {( c + {2}^{n} )}_{b} = {c}_{b} , ∀ b = [ 0 , n - 1 ] {and \\ ( c + {2}^{n} )}_{n} = 1 , ∀ c = 0 , 1 , 2 , … , {2}^{n} - 1 \\ ∴ ( 5 ) a \cdot {\prod }_{b = 0}^{n - 1} {[ md ( {r}^{{2}^{b}} ) ]}^{{c}_{b}} \cdot {\prod }_{ b = n}^{n} {[ md ( {r}^{{2}^{b}} ) ]}^{1} = a \cdot {\prod }_{b = 0}^{n - 1} {[ md ( {r}^{{2}^{b}} ) ]}^{{c}_{b}} \cdot md ( {r}^{n} ) ( 6 )$$

$$( a ) When c = {2}^{n - 1} , {2}^{n - 1} + 1 , {2}^{n - 1} + 2 , … , {2}^{n} - 1 , \\ ∵ ⌈ {log}_{2} ( c + 1 ) ⌉ - 1 = n - 1 , \\ ∴ {\prod }_{b = 0}^{n - 1} {[ md ( {r}^{{2}^{b}} ) ]}^{{c}_{b}} = {\prod }_{b = 0}^{⌈ {log}_{2} ( c + 1 ) ⌉ - 1} [ md ( {r}^{{2}^{b}} ) ] {c}_{b} \\ ( b ) When c = 0 , 1 , 2 , … , {2}^{n - 1} - 1 , \\ ∵ ⌈ {log}_{2} ( c + 1 ) ⌉ - 1 < n - 1 and Lemma 1 \text{:} {c}_{b} = 0 , ∀ b > ⌈ {log}_{2} ( c + 1 ) ⌉ - 1 \\ ∴ {\prod }_{b = 0}^{n - 1} {[ md ( {r}^{{2}^{b}} ) ]}^{{c}_{b}} = {\prod }_{b = 0}^{⌈ {log}_{2} ( c + 1 ) ⌉ - 1} {[ md ( {r}^{{2}^{b}} ) ]}^{{c}_{b}} \cdot {\prod }_{b = ⌈ {log}_{2} ( c + 1 ) ⌉}^{n - 1} {[ md ( {r}^{{2}^{b}} ) ]}^{{c}_{b}} = {\prod }_{b = 0}^{⌈ {log}_{2} ( c + 1 ) ⌉ - 1} {[ md ( {r}^{{2}^{b}} ) ]}^{{c}_{b}} \cdot 1 = {\prod }_{b = 0}^{⌈ {log}_{2} ( c + 1 ) ⌉ - 1} {[ md ( {r}^{{2}^{b}} ) ]}^{{c}_{b}} \\ ( a ) , ( b ) ⇒ ( 6 ) = a \cdot {\prod }_{b = 0}^{⌈ {log}_{2} ( c + 1 ) ⌉ - 1} {[ md ( {r}^{{2}^{b}} ) ]}^{{c}_{b}} \cdot md ( {r}^{b} ) = choice ( c ) \cdot md ( {r}^{n} )$$

Thus is proved Lemma III.

Theorem II: If

$$choice ( c ) = a \cdot {\prod }_{b = 0}^{⌈ {log}_{2} ( c + 1 ) ⌉ - 1} {[ md ( {r}^{{2}^{b}} ) ]}^{{c}_{b}} ,$$

choice(0)˜choices(2ⁿ−1), ∀nεN feature that they can generate 2ⁿ sets of geometric sequences each having α, an identical common ratio r, and a total number of terms 2ⁿ.

### Proof:

| When n = 1, choice(0) = a, and | | |
|---|---|---|
| choice(1) = a · md(r²^{^{a}}) = a · md(r¹) = a · md(r). | | |
| $When md ( r ) = \frac{1}{r} ,$ | | |
| $\begin{matrix}choice ( 1 ) = a \cdot \\ md ( r ) \\ = a \cdot \frac{1}{r}\end{matrix}$ | choice(0) = a | |
| When md(r) = r, | | |
| | choice(0) = a | $\begin{matrix}choice ( 1 ) = a \cdot \\ md ( r ) \\ = a \cdot r\end{matrix}$ |

There are 2ⁿ=2¹=2 sets of geometric sequences each having α, an identical common ratio r, and a total number of terms 2ⁿ=1¹=2.

When n=2,

it is learned from Lemma III that choice(c+2¹)=choice(c)·md(r²^{¹}), ∀c=0,2¹−1=0,1.

Express 2 of choice(2) in the binary system.

Thus, choice(2)=choice(0+2¹)=choice(0)·md(r²^{¹})=choice(0)·md(r²).

Express 3 of choice(3) in the binary system.

Thus, choice(3)=choice(1+2¹)=choice(1)+md(r²^{^{l}})=choice(1)+md(r²).

$When md ( {r}^{2} ) = \frac{1}{{r}^{2}} ,$

| | | | | |
|---|---|---|---|---|
| $\begin{matrix}choice ( 3 ) = choice \\ ( 1 ) \cdot \frac{1}{{r}^{2}} \\ = a \cdot \frac{1}{r} \frac{1}{{r}^{2}} \\ = a \cdot \frac{1}{{r}^{2}}\end{matrix}$ | $\begin{matrix}choice ( 2 ) = choice \\ ( 0 ) \cdot \frac{1}{{r}^{2}} \\ = a \cdot \frac{1}{{r}^{2}}\end{matrix}$ | $\begin{matrix}choice ( 1 ) = a \cdot \\ md ( r ) \\ = a \cdot \frac{1}{r}\end{matrix}$ | choice (0) = a | |
| | $\begin{matrix}choice ( 2 ) = choice \\ ( 0 ) \cdot \frac{1}{{r}^{2}} \\ = a \cdot \frac{1}{{r}^{2}}\end{matrix}$ | $\begin{matrix}choice ( 3 ) = choice \\ ( 1 ) \cdot \frac{1}{{r}^{2}} \\ = a \cdot r \cdot \frac{1}{{r}^{2}} \\ = a \cdot \frac{1}{r}\end{matrix}$ | choice (0) = a | $\begin{matrix}choice ( 1 ) = a \cdot \\ md ( r ) \\ = a \cdot r\end{matrix}$ |

When md(r²) = r²,

| | | | | |
|---|---|---|---|---|
| $\begin{matrix}choice ( 1 ) = a \cdot \\ md ( r ) \\ = a \cdot \frac{1}{r}\end{matrix}$ | choice (0) = a | $\begin{matrix}choice ( 3 ) = choice \\ ( 1 ) \cdot {r}^{2} \\ = a \cdot \frac{1}{r} \cdot {r}^{2} \\ = a \cdot r\end{matrix}$ | $\begin{matrix}choice ( 2 ) = choice \\ ( 0 ) \cdot {r}^{2} \\ = a \cdot {r}^{2}\end{matrix}$ | |
| | choice (0) = a | $\begin{matrix}choice ( 1 ) = a \cdot \\ md ( r ) \\ = a \cdot r\end{matrix}$ | $\begin{matrix}choice ( 2 ) = choice \\ ( 0 ) \cdot {r}^{2} \\ = a \cdot {r}^{2}\end{matrix}$ | $\begin{matrix}choice ( 3 ) = choice \\ ( 1 ) \cdot {r}^{2} \\ = a \cdot r \cdot {r}^{2} \\ = a \cdot {r}^{3}\end{matrix}$ |

As shown in abovementioned cases of

$$md ( {r}^{2} ) = \frac{1}{{r}^{2}} and md ( {r}^{2} ) = {r}^{2} ,$$

when n=2, there are 2ⁿ=2²=4 sets of geometric sequences each having α, an identical common ratio r, and a total number of terms 2ⁿ2²=4.

Suppose that when n=k, Theorem I is true, i.e. there are 2^{k} sets of arithmetic sequences each having α, an identical common ratio r, and a total number of terms 2^{k}:

| | | | | | | | | |
|---|---|---|---|---|---|---|---|---|
| $a \cdot \frac{1}{{r}^{{2}^{k} - 1}}$ | $a \cdot \frac{1}{{r}^{{2}^{k} - 2}}$ | $a \cdot \frac{1}{{r}^{{2}^{k} - 3}}$ | . . . | a | | | | |
| | $a \cdot \frac{1}{{r}^{{2}^{k} - 2}}$ | $a \cdot \frac{1}{{r}^{{2}^{k} - 3}}$ | . . . | a | a · r | | | |
| | | $a \cdot \frac{1}{{r}^{{2}^{k} - 3}}$ | . . . | a | a · r | a · r² | | |
| | | | . . . | . . . | . . . | . . . | . . . | |
| | | | | a | a · r | a · r² | . . . | a · r²^{^{k}}⁻¹ |

When n=k+1,

It is learned from Lemma III that choice(c+2^{k})=choice(c)·md(r²^{ⁿ}), ∀c=0,1,2, . . . , 2ⁿ−1.

When

$$md ( {r}^{{2}^{k}} ) = \frac{1}{{r}^{{2}^{k}}} ,$$

2^{k} rows are generated in the table. As the next term is formed via multiplying the current term and

$$\frac{1}{{r}^{{2}^{k}}} ,$$

the next term is arranged at the left of the current term in the table. When md(r²^{^{k}})=r²^{^{k}}, there are also 2^{k} rows. As the next

term is formed via multiplying the current term and r²^{^{k}}, the next term is arranged at the right of the current terra in the table. As shown in abovementioned eases of

$$md ( {r}^{{2}^{k}} ) = \frac{1}{{r}^{{2}^{k}}} and md ( {r}^{{2}^{k}} ) = {r}^{{2}^{k}} ,$$

when n=k+1, there are totally 2^{k}+2^{k}=2^{k+1} sets of geometric sequences each having α, an identical common ratio, and a total number of terms 2^{k+1}. Thus is proved Theorem II.

Below, a two-choice multiple choice question and a four-choice multiple choice question are used as the embodiments to demonstrate how the present invention generates numerical choices in form of a geometric sequence for a numerical multiple choice question. Firstly, define a numerical multiple choice question. The test question is “the length of a park trail is 40 m, and the jogging speed of a person is n1 to 10 m/sec; how much time will the person take to walk through the park trail?” The equation for solving the question is time=length÷speed40/n1 to 10. The correct answer is 40/n1 to 10 seconds. In the embodiment of a two-choice multiple choice question, the correct answer is 40/n1 to 10 seconds, and Choice 1 is (40/n1 to 10)*md(r) seconds, wherein n1 to 10 is a random integer number of from 1 to 10. In this embodiment, n1 to 10 assigned to be 5, and the correct answer is 8 seconds. In this embodiment, r of md(r) is assigned to be 1. However, r may be a random positive or negative integer in the present invention. Further, X is assigned to be 0 or 1 so as to vary the order of die correct answer appearing in the sequence of the numerical choices.

When X=0, the numerical choices are calculated as follows:

Choice 0 (the correct answer)=(40/n1 to 10)=(40/5)=8;

Choice 1=(40/n1 to 10)·(0.5+X*1.5)=(40/5)·(0.5÷0*1.5)=(40/5)·0.5=4.

The choices arranged from large to small are 8, 4. The correct answer is the largest one among the choices.

When X=1, the numerical choices are calculated as follows:

Choice 0 (the correct answer)=(40/n1 to 10)=(40/5)=8;

Choice 1=(40/n1 to 10) (0.5+X*1.5)=(40/5)·(0.5+1*1.5)=(40/5)·2=16.

The choices arranged from large to small are 16, 8. The correct answer is the second largest one among the choices.

Next, a four-choice multiple choice question is used as the embodiment to demonstrate die present invention. Similarly, X is 0 or 1 in the embodiment. From Lemma III, it is learned that choice(c+2¹)=choice(c)·md(r²^{¹}). Four numerical choices of the multiple choice question are calculated as follows:

$$Choice 0 ( the correct answer ) = choice ( 0 ) = a = ( 40 / n 1 to 10 ) ;$$

$$Choice 1 = choice ( 1 ) = a \cdot md ( {r}^{{2}^{0}} ) = a \cdot md ( {r}^{1} ) = a \cdot md ( r ) = ( 40 / n 1 to 10 ) * ( 0.5 + X * 1.5 ) ;$$

$$Choice 2 = choice ( 2 ) = choice ( 0 + {2}^{1} ) = choice ( 0 ) \cdot md ( {r}^{{2}^{1}} ) = choice ( 0 ) \cdot md ( {r}^{2} ) = ( 40 / n 1 to 10 ) * ( 0.25 + {X}_{2} * 3.75 ) ;$$

$$and$$

$$Choice 3 = choice ( 3 ) = choice ( 1 + {2}^{1} ) = choice ( 1 ) + md ( {r}^{{2}^{1}} ) = choice ( 1 ) + md ( {r}^{2} ) = ( 40 / n 1 to 10 ) * ( 0.5 + X * 1.5 ) * ( 0.25 + {X}_{2} * 3.75 ) ,$$

wherein n1 to 10 is a random integer number of from 1 to 10, and wherein md(2)=(0.5+X*1.5) and md(4)=(0.25+X₂*3.75), wherein either of X and X₂ is a random integer number selected from 0 and 1. In this embodiment, n1 to 10 is assigned to be 5, and (X, X₂) have four combinations: (0, 0), (1, 0), (0, 1) and (1, 1).

$$When ( X , {X}_{2} ) is ( 0 , 0 ) , \\ Choice 0 ( the correct answer ) = ( 40 / n 1 to 10 ) = ( 40 / 5 ) = 8 ;$$

$$Choice 1 = ( 40 / n 1 to 10 ) * ( 0.5 + X * 1.5 ) = ( 40 / 5 ) + ( 0.5 + 0 * 1.5 ) = 8 * 0.5 = 4 ;$$

$$Choice 2 = ( 40 / n 1 to 10 ) * ( 0.25 + {X}_{2} * 3.75 ) = ( 40 / 5 ) + ( 0.25 + 0 * 3.75 ) = 8 * 0.25 = 2 ;$$

$$and$$

$$Choice 3 = ( 40 / n 1 to 10 ) * ( 0.5 + X * 1.5 ) * ( 0.25 + {X}_{2} * 3.75 ) = ( 40 / 5 ) * ( 0.5 + 0 * 1.5 ) + ( 0.25 + 0 * 3.75 ) = 8 * 0.5 * 0.25 = 1.$$

The choices arranged from large to small are 8, 4, 2, 1. The correct answer is the largest one among the choices.

$$When ( X , {X}_{2} ) is ( 1 , 0 ) , \\ Choice 0 ( the correct answer ) = ( 40 / n 1 to 10 ) = ( 40 / 5 ) = 8 ;$$

$$Choice 1 = ( 40 / n 1 to 10 ) * ( 0.5 + X * 1.5 ) = ( 40 / 5 ) + ( 0.5 + 1 * 1.5 ) = 8 * 2 = 16 ;$$

$$Choice 2 = ( 40 / n 1 to 10 ) * ( 0.25 + {X}_{2} * 3.75 ) = ( 40 / 5 ) + ( 0.25 + 0 * 3.75 ) = 8 * 0.25 = 2 ;$$

$$and$$

$$Choice 3 = ( 40 / n 1 to 10 ) * ( 0.5 + X * 1.5 ) * ( 0.25 + {X}_{2} * 3.75 ) = ( 40 / 5 ) * ( 0.5 + 1 * 1.5 ) + ( 0.25 + 0 * 3.75 ) = 8 * 2 * 0.25 = 4.$$

The choices arranged from large to small are 16, 8, 4, 2. The correct answer is the second largest one among the choices.

$$When ( X , {X}_{2} ) is ( 0 , 1 ) , \\ Choice 0 ( the correct answer ) = ( 40 / n 1 to 10 ) = ( 40 / 5 ) = 8 ;$$

$$Choice 1 = ( 40 / n 1 to 10 ) * ( 0.5 + X * 1.5 ) = ( 40 / 5 ) + ( 0.5 + 0 * 1.5 ) = 8 * 0.5 = 4 ;$$

$$Choice 2 = ( 40 / n 1 to 10 ) * ( 0.25 + {X}_{2} * 3.75 ) = ( 40 / 5 ) + ( 0.25 + 1 * 3.75 ) = 8 * 4 = 32 ;$$

$$and$$

$$Choice 3 = ( 40 / n 1 to 10 ) * ( 0.5 + X * 1.5 ) * ( 0.25 + {X}_{2} * 3.75 ) = ( 40 / 5 ) * ( 0.5 + 0 * 1.5 ) + ( 0.25 + 1 * 3.75 ) = 8 * 0.5 * 4 = 16.$$

The choices arranged from large to small are 32, 16, 8, 4. The correct answer is the third largest one among the choices.

$$When ( X , {X}_{2} ) is ( 1 , 1 ) , \\ Choice 0 ( the correct answer ) = ( 40 / n 1 to 10 ) = ( 40 / 5 ) = 8 ;$$

$$Choice 1 = ( 40 / n 1 to 10 ) * ( 0.5 + X * 1.5 ) = ( 40 / 5 ) + ( 0.5 + 1 * 1.5 ) = 8 * 2 = 16 ;$$

$$Choice 2 = ( 40 / n 1 to 10 ) * ( 0.25 + {X}_{2} * 3.75 ) = ( 40 / 5 ) + ( 0.25 + 1 * 3.75 ) = 8 * 4 = 32 ;$$

$$and$$

$$Choice 3 = ( 40 / n 1 to 10 ) * ( 0.5 + X * 1.5 ) * ( 0.25 + {X}_{2} * 3.75 ) = ( 40 / 5 ) * ( 0.5 + 1 * 1.5 ) + ( 0.25 + 1 * 3.75 ) = 8 * 2 * 4 = 64.$$

The choices arranged from large to small are 64, 32, 16, 8. The correct answer is the fourth largest one among the choices. From the abovementioned examples, it is known that the variable X can be used to vary the order of the correct answer in the numerical choices.

In conclusion, the present invention proposes a choice generation method for a numerical multiple choice question, which applies to a numerical multiple choice question database, and which generates numerical choices in form of an arithmetic or geometric sequence, and which uses a random variable inside the equation to vary the order that the correct answer appears in the generated numeral choices.

The embodiments described above are only to exemplify the present invention but not to limit the scope of the present invention. Any equivalent modification or variation according to the characteristic or spirit of the present invention is to be also included within the scope of the present invention.

What is claimed is:

1. A choice generation method for a numerical multiple choice question comprising steps:
establishing a numerical multiple choice question, and obtaining a correct numerical answer of said numerical multiple choice question;
determining a count of numerical choices for said numerical multiple choice question; and
generating a plurality of said numerical choices either greater or smaller than said correct numerical answer according to a choice-answer relationship.

2. The choice generation method for a numerical multiple choice question according to claim 1, wherein said choice-answer relationship is expressed by
$$choice ( c ) = a + {\sum }_{b = 0}^{⌈ {log}_{2} ( c + 1 ) ⌉ - 1} pm ( d \cdot {2}^{ b} ) \cdot {c}_{b}$$
wherein choice(c) is a value of a cth numerical choice, a said correct numerical answer, and c_{b} the bth bit of c in a binary system.

3. The choice generation method for a numerical multiple choice question according to claim 2, wherein pm(d) is expressed by
pm(d)=−d+X*d*2
Wherein d is a common difference, and wherein X is a random integer variable of 0 or 1.

4. The choice generation method for a numerical multiple choice question according to claim 3, wherein said random integer variable X is used to vary order of said correct numerical answer appearing in a sequence of said numerical choices.

5. The choice generation method for a numerical multiple choice question according to claim 1, wherein said choice-answer relationship is expressed by
$$choice ( c ) = a \cdot {\prod }_{b = 0}^{⌈ {log}_{2} ( c + 1 ) ⌉ - 1} {[ md ( {r}^{{2}^{k}} ) ]}^{{c}_{b}}$$
wherein choice(c) is a value of a cth numerical choice, α said correct numerical answer, and c_{b} the bth bit of c in a binary system.

6. The choice generation method for a numerical multiple choice question according to claim 5, wherein md(r) is expressed by
$$md ( r ) = \frac{1}{r} + X * ( r - \frac{1}{r} )$$
wherein r is a common ratio, and wherein X is a random integer variable of 0 or 1.

7. The choice generation method for a numerical multiple choice question according to claim 6, wherein said random integer variable X is used to vary order of said correct numerical answer appearing in a sequence of said numerical choices.
